(19) United States
(12) Patent Application Publication
(10) Pub. No.: US 2009/0048015 A1
(43) Pub. Date: Feb. 19, 2009

(54) Virtual floating layer for gaming machines, and gaming machines incorporating the same

(75) Inventor: Angelo Palmisano, Crystal Lake, IL (US)

Correspondence Address: NIXON & VANDERHYE, PC, 901 NORTH GLEBE ROAD, 11TH FLOOR, ARLINGTON, VA, 22203, US

(73) Assignee: PALTRONICS, INC., Crystal Lake, IL (US)

(21) Appl. No.: 11/889,971

(22) Filed: Aug. 17, 2007

(51) Int. Cl. G06F 17/00

(52) U.S. Cl. 463/25; 463/42

(57) ABSTRACT

The exemplary embodiments described herein relate to gaming machines and, more particularly, to gaming machines that are configured to display one or more virtual floating layers on one or more displays thereon. In each gaming machine, a main screen is configured to display a first game-related event. A top box is configured to display a second game-related event. A video controller is configured to provide to the main screen and/or the top box a floatable layer. The floatable layer includes at least one ancillary event. A network interface is configured to communicate information between the gaming machine and a central system over a network in substantially real-time. The floating layers may include, for example, interactive gaming, bonusing, entertainment, promotional, informational, banking, and/or service-oriented content.

### TECHNICAL FIELD

The exemplary embodiments described herein relate to gaming machines and, more particularly, to gaming machines that are configured to display one or more virtual floating layers on one or more displays thereon. Such floating layers may include, for example, interactive gaming, bonusing, entertainment, promotional, informational, banking, and/or service-oriented content.

### BACKGROUND AND SUMMARY

For years, gaming machines (e.g., of the type typically found in casinos, on riverboats, and/or in other gambling establishments) have provided patrons with enjoyment and proprietors with revenue. Broadly speaking, they have evolved from simple, classic slot machines featuring mechanical arms that a patron would pull, to more complicated video-based versions of slots, poker, and other games, with one or more buttons sometimes replacing the functions served by the mechanical arm. Further changes have included, for example, incorporating multiple displays to support advertising and/or even additional games.

As the desire for more engaging entertainment has increased yet further, some providers began configuring their gaming machines for use in a networked environment. FIG. 1 is a current gaming machine 100 within a current gaming system of the type typically used in casinos. For aesthetic purposes, belly glass 101 often is provided. Each gaming machine includes a first display area 102, generally referred to as a game screen. The game screen 102 traditionally has been where most of the “action” happens. For example, the game screen 102 may simulate the rolling of the reels on a slot machine and thus indicate whether the user has won any money. A second display area 104, generally referred to as a top box, also is provided. The top box 104 may display additional information for the patron, such as, for example, advertising, generally entertaining animations, bonus game opportunities, etc.

The game screen 102 and/or the top box 104 may be touch screen monitors and thus accept input directly. Such input may pertain to, for example, the number of credits to bet, the way in which a bet may be made, whether to initiate a bet, whether to cash out, etc. In other cases, a separate control panel (not shown) may be provided to enable the same and/or similar functionality.

The gaming machine 100 also is provided with a player tracking module (PTM) area 106. The PTM area 106 includes a payment acceptor (e.g., a card reader, a coin and/or dollar acceptor, etc.) 108 to accept payment (e.g., cash, an encoded card storing credits, or the like) from the patron. A small display screen (or PTM) 110 is located in the PTM area 106 and enables the patron to access certain other more individualized services. For example, the PTM 110 may enable the patron to call an attendant to order drinks. In such a case, the PTM 110 may cause the candle 112 (e.g., one or more differently colored lights) of the gaming machine 100 to become lit to signal to casino personnel that the patron is requesting some form of service. The PTM 110 typically is an LCD screen and typically is operated using control panel 111.

The PTM 110 may have a computer-readable storage medium (not shown) associated therewith. The computer-readable storage medium typically is a small flash drive, hard drive, or other suitable memory location. Information may be distributed to the PTM 110 and at least temporarily stored on the computer-readable storage medium. In this way, it is possible to provide some media offerings to the gaming machine 100 for display by the PTM 110. More particularly, the computer-readable storage medium is used as a buffer for the media offerings that ultimately may be displayed by the PTM 110.

The game screen 102 and the top box 104, and the respective associated circuitry, typically are provided by a single company. The PTM 110 often is provided by another vendor. Sometimes, the PTM 110 will be integrated into the gaming machine 100. However, it is often the case that the gaming machine 100 will be retrofitted with a PTM 110. As such, the hardware and software systems for the game screen 102 and the top box 104 typically are independent of the hardware and software systems for the PTM 110.

This separation often makes integration between the various components cumbersome, impossible, and/or not worthwhile. Thus, to accommodate these features related to the PTM area 106, gaming machines are equipped with special purpose hardware. It will be appreciated that the player management tracking and information management features provided typically exist outside of the normal base game(s) environment, which deal directly with game play rather than ancillary services, patron interaction, feedback, and the like.

FIG. 2 shows a plurality of gaming machines 100 being located on a casino floor and being connected in a networked environment. To this end, a plurality of central systems 202 are included to collect and/or distribute data, as necessary. Each gaming machine 100 may be connected to one or more of the central systems 202 via a propriety link. Such proprietary links typically are based on unicast, broadcast, multi-drop, and/or other suitable network protocols. Although proprietary protocols sometimes are implemented, the typical effect is that data is transmitted to/from the central systems 202 over a broadcast channel or to one or more targeted groups (e.g., a bank of gaming machines in a row, in a particular area of the gaming floor, etc.) over connections 204.

There are at least three separate systems or modules comprising the central systems 202. FIG. 3 is a more detailed partial schematic view of the central systems 202 shown in FIG. 2. A first system, management and accounting subsystem 302, provides management and accounting functions, also sometimes called auditing functions. Typically, these functions gather and/or report coin-in and coin-out operations, door openings (e.g., when a gaming machine is serviced), service cycles in general, ticket replacements, and the like. This activity generally is linked to the game being played on the gaming machine and/or the gaming machine itself.

A second system, player tracking subsystem 304, provides player tracking functions. More specifically, such systems link players on the gaming floor to particular activities undertaken by the players on the gaming floor. The information typically tracked for each player includes, for example, the session of game play (e.g., date, time, location, type of machine, type of game, etc.) as well as the individual's profile (e.g., name, address, and/or other identifying information such as hair color). The player tracking subsystem 304 also may interface with the PTM 110 of a particular gaming machine 100.

A third system, bonusing subsystem 306, provides enhancements which may or may not be related to the base game. Such enhancements may relate to bonusing, progressive games, mystery, secondary games, random rewards (e.g., as disclosed in U.S. Pat. No. 6,626,758, the entire contents of which are hereby incorporated herein by reference), etc. This system typically interfaces with the PTM 110.

Other systems may be included in the central systems 202. For example, other modules may be provided for detecting cash-in, cash out and/or data mining purposes. Data mining may be used, for example, in connection with marketing activities, accounting and/or auditing activities, etc.

Reports 300 may be generated by the central systems 202, for example, to report on earnings, operational efficiencies, repairs, etc. Such reports 300 also may be the result of the above-described data mining operations. The central systems 202 are connected to the gaming machines 100 via the network connection 310.

FIG. 4 is an illustrative flowchart demonstrating a typical process involving a patron using a gaming machine of FIG. 1 and in the networked environment of FIG. 2. In step S402, the patron is recognized. This may be accomplished using a programmable smart card issued to the patron, which may be inserted into or otherwise read by the gaming machine and understood by the central systems. After the patron is recognized, the patron's profile is retrieved from the relevant database(s) in step S404. Information that may be retrieved may include the patron's name, room number, number of credits, status (e.g., normal user, preferred patron, etc.), and the like. In step S406, the game to be played on the gaming machine is initialized according to the retrieved information where appropriate. The patron plays the game in step S408. In step S410, the database(s) is/are updated based on the plays, when appropriate. For example, after a certain number of plays or on a random basis, a random reward or bonusing event may be triggered for the patron. Also, in step S412, the patron's requests are fulfilled, where appropriate. For example, the patron may use the PTM to call for drink service or the like, thereby actuating the candle on the gaming machine.

While such gaming machines and gaming systems have been effective in providing additional entertainment and service options, they unfortunately suffer from several drawbacks. Thus, the ability to realize yet further enhancements is reduced. Some disadvantages relate to the high cost and technical difficulties associated with implementing such systems. Currently, such systems require three pieces of hardware to address the top box, PTM, and gaming machine, in addition to the backend systems. Configuring such hardware is cumbersome, for example, in terms of connecting the hardware among and between gaming machines. Consider a gaming floor with 5,000 gaming machines. To suitably equip the gaming machines would require the installation and configuration of 15,000 hardware components, in addition to the installation and configuration of the backend components. Scalability has been reduced according to such installation, configuration, and coordination difficulties. The reduced amount, or even complete absence, of interoperability between the hardware components also produces strains on networking technologies in terms of addressability, management, and accounting.

For similar reasons, mass deployment of media-type features also has been difficult. Size limitations of the computer-readable storage media on gaming machines have effectively reduced the amount of content and number of options available to patrons (e.g., via the PTM). Moreover, it has not been feasible to deliver live television, entertainment, and other media-type features. Live feeds have been made difficult (and often impossible) because of the store-forward nature of the memory locations on each gaming machine, bandwidth requirements, and/or difficulties associated with addressing individual gaming machines in the proprietary network environment (e.g., based on unicast, multidrop, etc.).

Current implementations typically are restricted to one means of deployment, particularly for the PTM. That is, configurations can only be made taking into account the particular hardware components selected and/or already in place. In such cases, for example, the particular gaming machine dictates the size, location, and other aspects of the PTM. Limited “real estate” and implementation difficulties have led to homogenous configurations. Similarly, it is difficult to take into account patrons' different preferences for designs, layouts, and desired ergonomic layouts. Moreover, to replace the base game(s) on a gaming machine, the gaming machine typically must either have its internal components replaced or be replaced in its entirety to accommodate more advanced and/or modern games. Thus, there is often a large investment required in modernizing and/or upgrading an existing floor. These problems may be exacerbated as additional gaming machines are added and tax the network and infrastructure yet further, in terms of number and types of systems that must be integrated.

Thus, it will be appreciated that there is a need in the art for improved gaming machines and systems and methods for accommodating the same.

Although improvements have been made to gaming machines in the ways described above, corresponding improvements to table games (e.g., blackjack, poker, proprietary table games, etc.) have not been made. FIG. 5 is a conventional table game. The table 500 includes seven positions with betting areas 502, which is customary in (although in no way limiting of) blackjack tables, for example. There is one dealer per table. Betting is done manually by patrons, and involves cash or chips. In some more advanced table games, side wagers may be made manually using cash or chips, and/or using a coin insert located directly in the table. Cash or chips typically are awarded for side wagers and for the base game.

A pit, or area of table games within a casino, typically comprises 2-12 such tables 500. There may be multiple pits within a single casino. One or two pit bosses typically are assigned to a pit. The pit bosses are charged with enforcing the rules within a pit, awarding bonuses, rating players based on their performances, etc. Thus, dealers and pit bosses must use conventional manual techniques for player identification (e.g., to recognize repeat patrons, high-stakes gamblers, professionals, etc.), player rating, player awards, and the like. Such manual techniques typically involve little more than a pencil, pad of paper, and a “best guess” as to the amount of time, money, and throughput of a particular patron at a particular game.

Unfortunately, these manual processes have several drawbacks. For example, the rating of patrons' play performance often is arbitrary and manual. Typically, a pit boss watches and estimates the amount wagered, the amount earned, the amount of time played, etc. These estimates typically are not quantified with a great degree of precision. Similarly, award criteria typically are arbitrary and awards are made manually. Typically, pit bosses will estimate the amount of time a player has been at a table, the amount of money spent, etc., in determining whether, and how much, to award to a patron sitting at a table game.

There are also reduced operational efficiencies related to betting and bonus payouts/credits. For example, there is a general inability to provide a promotional bonus program that is in-line with the balance of the casino operation. This is because, in part, awards are made arbitrarily without quantified knowledge of the betting at the particular table, in the pit, or in the rest of the casino, especially with non-table games. There also are logistical complications for patrons, dealers, and pit bosses relating to managing cash, coins, or chips during game play. Such problems are even more complicated in multi-property settings, where it would be desirable to make awards and/or provide bonuses in accordance with a multi-property casino operation.

Finally, the entertainment on conventional tables is reduced to the particular form of the table game being played. There are no on-demand services available to the patrons as a table, much less on-demand services provided to each patron individually. Moreover, there is a literal “call” system for a reduced number of ancillary services, typically including only drink and cash-out services.

The drawbacks described above with respect to table games are surprising, given that 32% of gaming positions are tables and that a significant amount of revenue is derived therefrom.

Thus, it will be appreciated that there is a need in the art for improved table games, and systems and methods for accommodating the same.

In certain exemplary embodiments, a gaming machine is provided. A main screen is configured to display a first game-related event. A top box is configured to display a second game-related event. A video controller is configured to provide to the main screen and/or the top box a floatable layer, with the floatable layer including at least one ancillary event. A network interface is configured to communicate information between the gaming machine and a central system over a network in substantially real-time.

In certain other exemplary embodiments, a floatable layer to be provided to a main screen configured to display a first game-related event and/or a top box configured to display a second game-related event of a gaming machine, is provided. The floatable layer is configured to display at least one ancillary event. The gaming machine includes a network interface configured to communicate information between the gaming machine and a central system over a network in substantially real-time.

In still other exemplary embodiments, a gaming network including a plurality of gaming machines is provided. Each gaming machine comprises a main screen configured to display a first game-related event; a top box configured to display a second game-related event; a video controller configured to provide to the main screen and/or the top box a floatable layer, with the floatable layer including at least one ancillary event; and, a network interface configured to communicate information between the gaming machine and a central system over the network in substantially real-time.

In certain non-limiting implementations, the at least one ancillary event may be a floating player tracking module; a floating enhancement and/or bonusing opportunity; or a replacement game, with the replacement game being independent of any games displayed on the main screen and/or the top box. Also, in certain non-limiting implementations, the network may be a multicast network arranged in a plurality of layers.

These exemplary features, aspects, and advantages may be combined in various combinations ways to achieve yet further embodiments.

### BRIEF DESCRIPTION OF THE DRAWINGS

These and other features, aspects, and advantages will be better and more completely understood by reference to the following detailed description of exemplary illustrative embodiments in conjunction with the drawings, of which:

FIG. 1 is a current gaming machine within a current gaming system of the type typically used in casinos;

FIG. 2 shows a plurality of gaming machines being located on a casino floor and being connected in a networked environment;

FIG. 3 is a more detailed partial schematic view of the central systems 202 shown in FIG. 2;

FIG. 4 is an illustrative flowchart demonstrating a typical process involving a patron using a gaming machine of FIG. 1 and in the networked environment of FIG. 2;

FIG. 5 is a conventional table game;

FIG. 6 is an improved gaming machine connected to an improved gaming network in accordance with an exemplary embodiment;

FIG. 7 is an illustrative flowchart demonstrating a process involving a patron using an improved gaming machine, and in the improved networked environment, of FIG. 6, in accordance with an exemplary embodiment;

FIG. 8 is an improved table game in accordance with an exemplary embodiment;

FIG. 9A is a more detailed view of an improved patron position from the improved table game of FIG. 8 in accordance with an exemplary embodiment;

FIG. 9B is a simulated illustrative display on the improved patron position from FIG. 9A in accordance with an exemplary embodiment;

FIG. 10 is a more detailed view of a dealer interface from the improved table game of FIG. 8 in accordance with an exemplary embodiment;

FIG. 11A is a cross-sectional view of an illustrative inset bezel for connecting a display of FIG. 8 at a player position to the improved table game, in accordance with an exemplary embodiment;

FIG. 11B is a partial perspective view of the inset bezel of FIG. 11A in accordance with an exemplary embodiment;

FIG. 11C is a cross-section view of another illustrative inset bezel for connecting a display of FIG. 8 at a player position to the improved table game, in accordance with an exemplary embodiment;

FIG. 11D is a partial perspective view of the inset bezel of FIG. 11C in accordance with an exemplary embodiment;

FIG. 12 shows a plurality of improved table games being located on a casino floor and being connected in a improved networked environment in accordance with an exemplary embodiment;

FIG. 13 is a partial schematic view of a casino floor including connections to improved gaming machines and improved table games in accordance with an exemplary embodiment;

FIG. 14A is an illustrative menu screen for a personal concierge service in accordance with an exemplary embodiment;

FIG. 14B is an illustrative, generic flowchart for accessing the features of the personal concierge service in accordance with an exemplary embodiment;

FIG. 14C is an illustrative flowchart for requesting drinks via the personal concierge service in accordance with an exemplary embodiment;

FIG. 14D is an illustrative flowchart for requesting guest services via the personal concierge service in accordance with an exemplary embodiment;

FIG. 14E is an illustrative flowchart for making reservations via the personal concierge service in accordance with an exemplary embodiment; and,

FIG. 15 is an illustrative multi-property layout of improved gaming machines and improved table games in accordance with an exemplary embodiment.

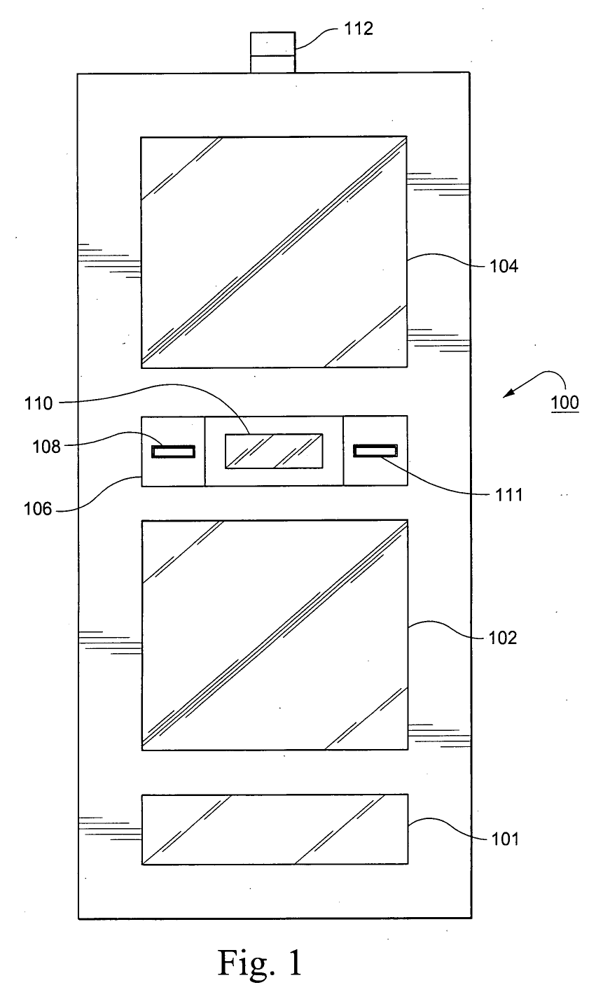

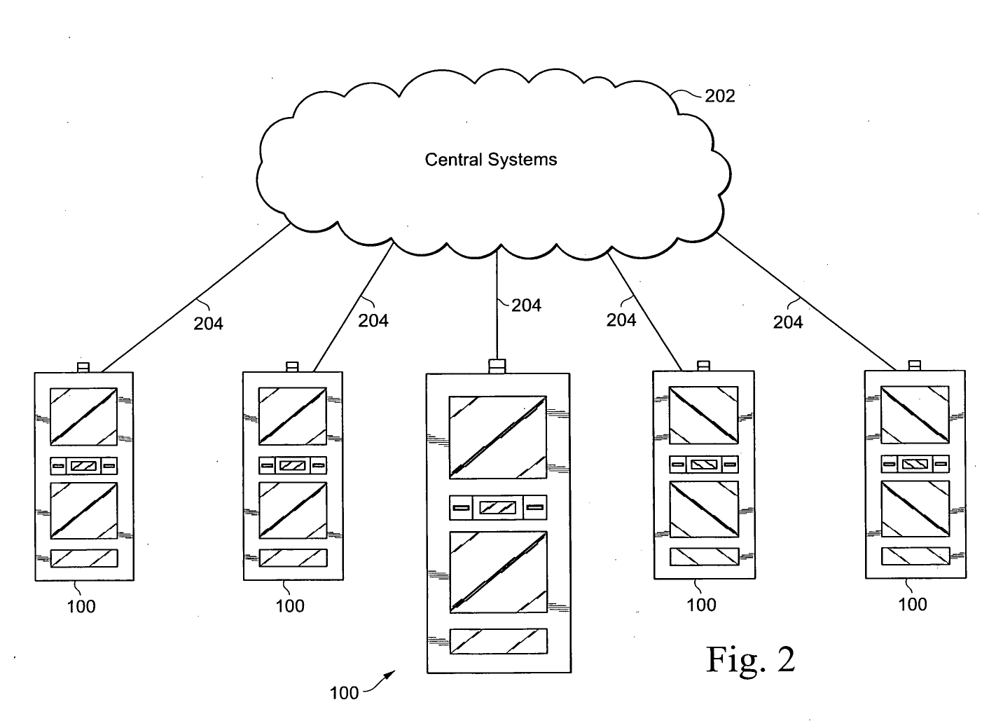

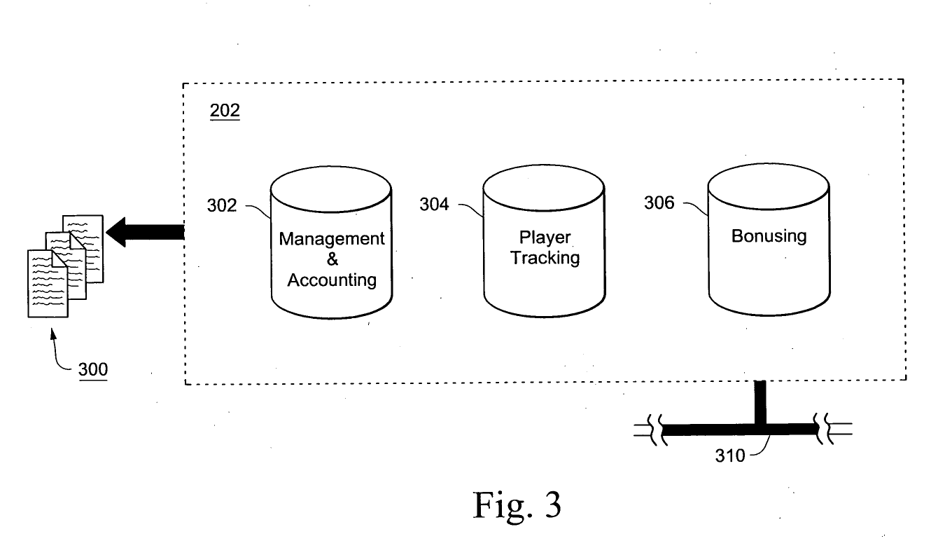

### DETAILED DESCRIPTION

The exemplary embodiments described herein relate to gaming machines and, more particularly, to gaming machines that are configured to display one or more virtual floating layers on one or more displays thereon. According to certain exemplary embodiments, in each gaming machine, a main screen is configured to display a first game-related event. A top box is configured to display a second game-related event. A video controller is configured to provide to the main screen and/or the top box a floatable layer. The floatable layer includes at least one ancillary event. A network interface is configured to communicate information between the gaming machine and a central system over a network in substantially real-time. The floating layers may include, for example, interactive gaming, bonusing, entertainment, promotional, informational, banking, and/or service-oriented content.

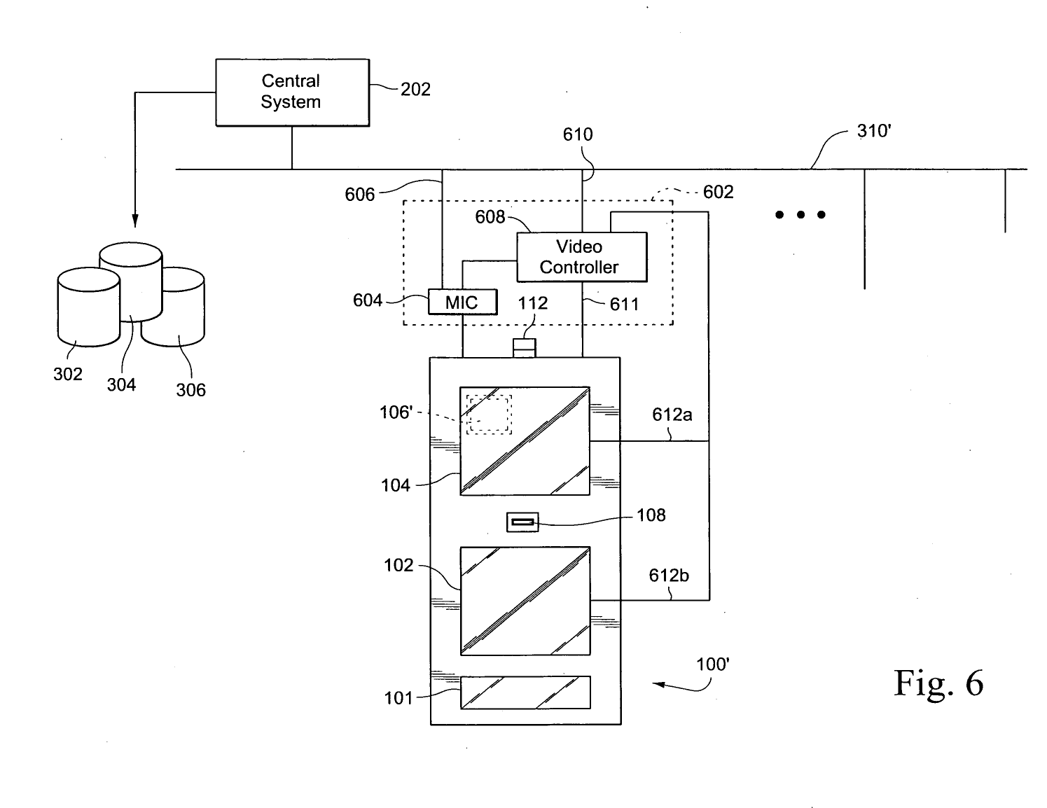

Referring now more particularly to the drawings, FIG. 6 is an improved gaming machine 100′ connected to an improved gaming network 310′ in accordance with an exemplary embodiment. Many of the components of the improved gaming machine 100′ may be the same as the conventional gaming machine 100. For example, decorative belly glass 101 may still be present. Additionally, a main game screen 102 (or first display) and a top box 104 (or second display) also may be present. To facilitate payment and/or user recognition, payment acceptor 108 also may be provided to the improved gaming machine 100′. Finally, lamp 112 also may be located on top of the improved gaming machine 100′. However, as will be described in greater detail below, the PTM area 106 of the conventional gaming machine 100 is absent. Moreover, as will be described in greater detail below, the virtual floating layer 106′ may be used to replace the functionality of much of the conventional PTM area 106 while also providing additional services to the patron instead of, or in addition to, conventional PTM services.

In accordance with certain exemplary embodiment, the components depicted in area 602 may be associated with each improved gaming machine 100′ in the casino. For example, such components may be located inside (e.g., in the cabinet) of each improved gaming machine 100′, or they may be located external to the improved gaming machine 100′. In certain other exemplary embodiments, such components may service one or more improved gaming machines 100′.

The components of area 602 include a MIC 604 and a Video controller 608. The MIC 604 communicates between the central systems 202 and the improved gaming machine 100′ over a data layer 606 of the improved network 310′. The MIC 604 also communicates data from the data layer 606 to the video controller 608. Each gaming machine typically is provided with a MIC 604, or machine interface card. The machine interface card, in general, provides a link between the network and the gaming machine. In general, the MIC provides an interface to the gaming machines such that data can be extracted from and/or provided to the gaming machines to/from the network. In certain exemplary embodiments, the MIC 604 may be implemented as hardware, software, firmware, and/or any suitable combination thereof. The video controller 608 communicates with the central systems 202 over a media layer 610. The video controller 608 is connected to the “video in” connection (not shown) on the main board (also not shown) of the improved gaming machine 100′ via connection 611. The video controller 608 also is connected to the top box 104 via connection 612a and to the main screen 102 via connection 612b. By way of example and without limitation, the top box 104 and/or the main screen 102 may be a LCD, TV, monitor, or the like, and the connections 612a-b from the video controller 608 may be connected thereto via “video in” connections. In general, these connections provide the primary video signals to all displays of a gaming machine such that content such as, for example, the main game, the top box content, the PTM content, ancillary services content, etc., is provided on the respective displays. In essence, in certain exemplary embodiments, video will be fed into the video controller and then fed back out to the appropriate respective displays.

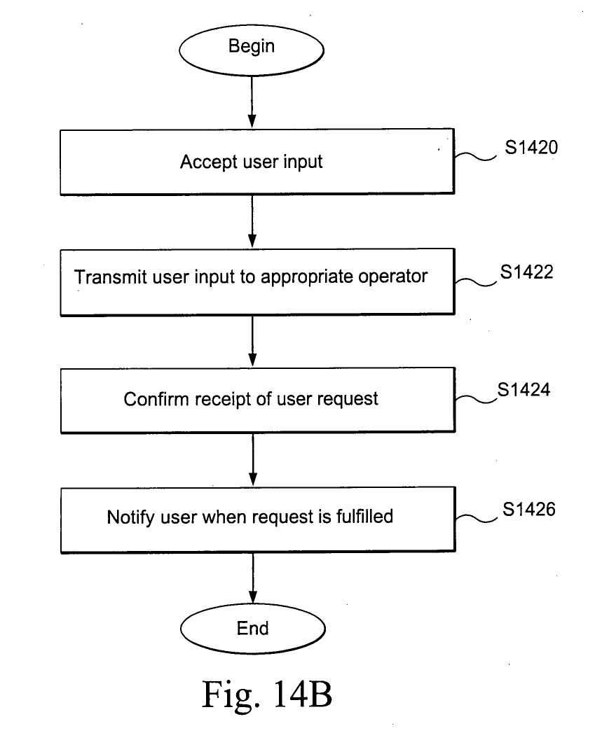

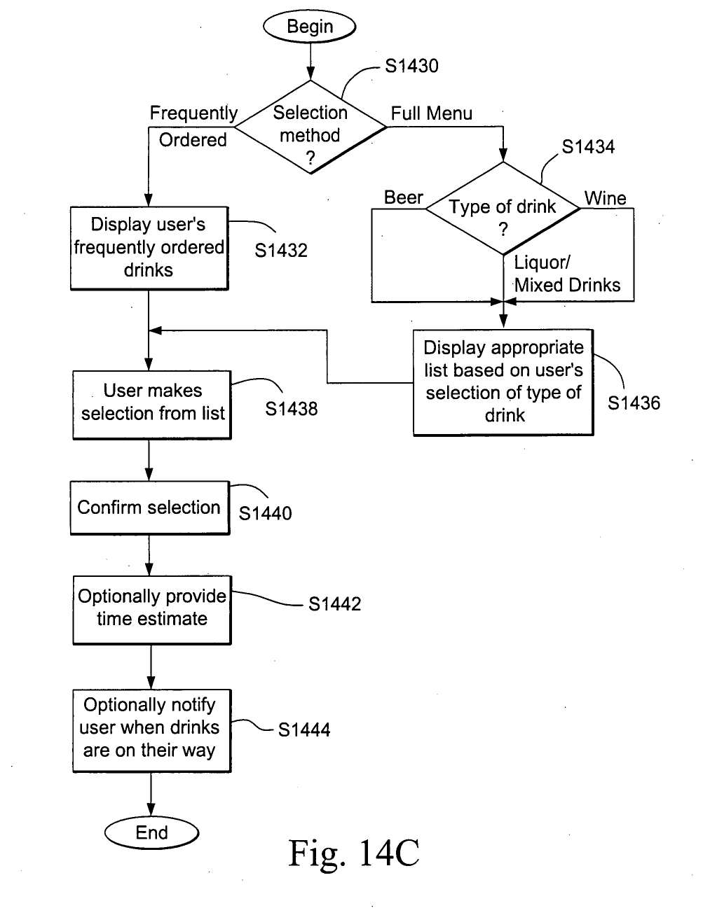

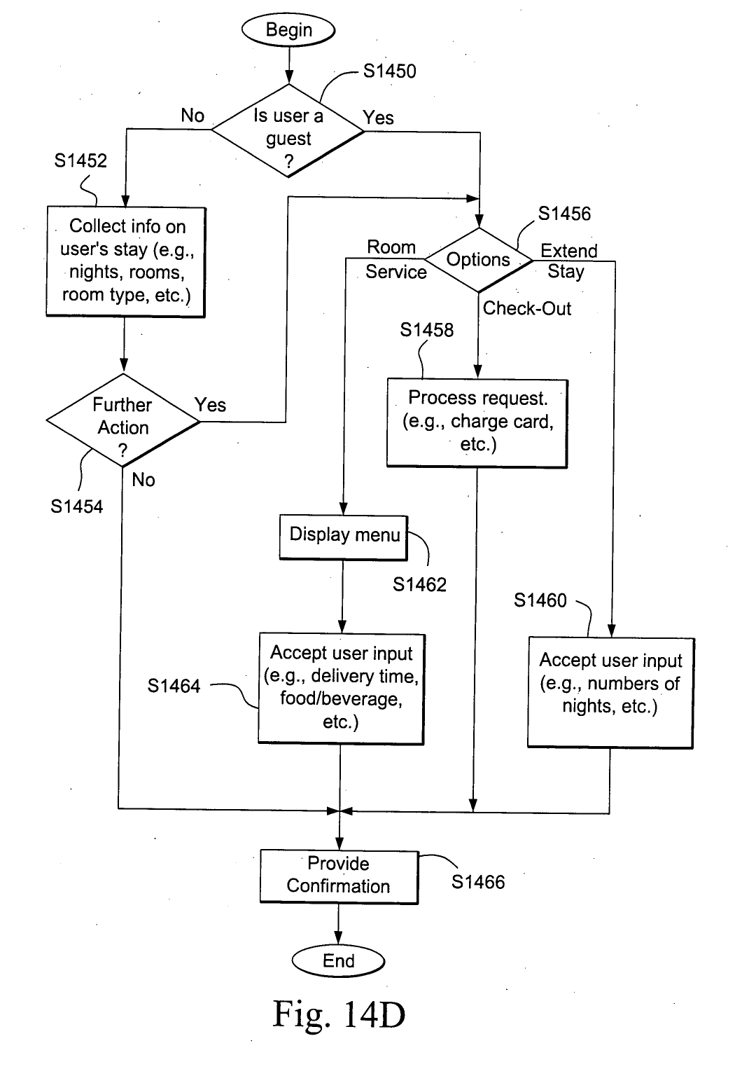

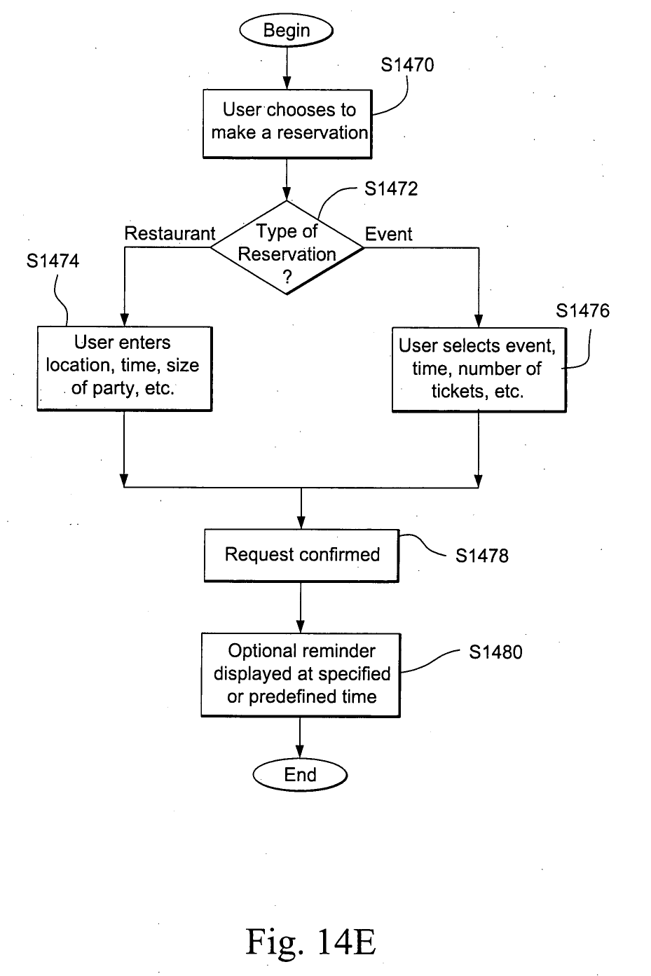

Also, a game management module optionally may be further provided for downloading and/or acquiring media, for example, for a premium purchase price. Similarly, instructions, tips, hints, media content information, etc. optionally may be provided for the user based on a module operating in connection with the central systems 202 and also optionally may be provided at a premium price. These and/or other similar features may be accessed, for example, via the services described below with reference to FIG. 14A (or corresponding similar services).

As alluded to above, the improved network 310′ may have separate data and media layers associated therewith. Thus, in certain exemplary embodiments, the improved network 310′ may be implemented as a multicast network with one or more custom layers. This approach is different from conventional network architectures known to the casino market, which typically follow the protocols noted above and include a large amount of transport criteria that reduces the number of nodes with which a system can simultaneously and differentially interact. By implementing the improved network 310′ in these ways, it may be offered in wired and/or wireless form.

The central systems 202 may have associated therewith the management and accounting subsystem 302, player tracking subsystem 304, and bonusing subsystem 306, as described above. Thus, central systems 202 may provide configuration services. It also includes all inputs to live feeds, serves all media streams, etc.

Further details of the virtual floating layer 106′ will now be provided. As noted above, the virtual floating layer 106′ may replace many features of the conventional PTM area 106. Thus, by way of example and without limitation, the virtual floating layer 106′ may provide updatable and/or substantially real-time PTM data and/or a user interface for the patron. With respect to the former, this information may include customer feedback (e.g., the patron's name), play data, error codes, and the like. With respect to the latter, the existing touch screen may be used alone or in combination with another input mechanism (e.g., a plurality of buttons, a pointer, mouse, etc.).

The virtual floating layer 106′, still functioning in some ways like a conventional PTM, also may provide customer service interaction. For example, it may provide a personal concierge service, an interactive bar ordering system, an integrated property services module, a ticket ordering service, a restaurant reservation module, ticket ordering system, valet services, etc. These ancillary services are described in greater detail below, for example, with reference to FIGS. 14A-E.

The virtual floating layer 106′ also may provide live feeds. By way of example and without limitation, such live feeds may be streaming media such as, for example, e.g., movies, custom content for the venue, broadcast or cable or satellite television, etc.

The virtual floating layer 106′ also may provide bonus enhancement games, for example, of the types disclosed in U.S. Publication Nos. 2005/0085300 and 2007/0077997, the entire contents of each of which are incorporated herein by reference. Currently, bonus games both promotional and contributional, are provided on floor-wide and local group systems. The challenges of implementation relate to providing patrons with the interaction, playability, and real-time alerts, letting them know that they won and informing them why they won. Some current techniques involve overhead alarms, displays that communicate winning machines and their locations, as well as companion systems that incorporate additional non-game related hardware display components in every machine for the purpose of presenting these various prizes to the patron.

However, a bonus game (such as, for example, Mystery, Random Rewards, etc.) may be provided on a virtual floating layer on existing video display mediums currently on the gaming machine and/or in the gaming environment (e.g., not necessarily attached to any gaming machine, per se, like a kiosk). The virtual floating layer 106′ may provide the consumer with a comprehensive user interface that gives the patron information on the bonus program, the patron's status, the patron's prize amount won, histories, redemption options and, in addition, the ability to interact with the virtual device through the existing touch screen. Moreover, alerts may be sent directly to other gaming machines, overhead displays, kiosks, and the like using such virtual floating layers and/or other techniques appropriate to the destination devices.

In these above-mentioned exemplary embodiments, the virtual floating layer 106′ may have certain unique features. For example, it may be accessible using an existing touch screen interface on the gaming machine 100′. The virtual floating layer 106′ may be moved to either or both screens, anywhere on either or both screens. This may be accomplished, for example, by having the patron “drag and drop” the screen using the above-mentioned touch screen functionality. Similarly, the virtual floating layer 106′ may be sized and/or resized.

These positional and sizing characteristics may be based on the user's identity, user input, user profile (e.g., stored data and/or preferences, etc.), the status of the game or bonuses, etc. For example, a patron may choose to have a large virtual floating layer 106′ for a live boxing event, whereas a patron may choose to have a small virtual floating layer 106′ for routine credit updates. The virtual floating layer 106′ may be automatically increased in size and/or centered when a random reward is distributed, when a bonus game is made available, when a nearby gaming machine has been awarded a significant jackpot, etc. Conversely, the virtual floating layer 106′ may be automatically decreased in size after a period of inactivity, or it may be relocated to a remote part of the screen to make way for more pressing events (e.g., a jackpot being awarded on the main game screen 102).

Although the description provided above refers to a single virtual floating layer 106′, it will be appreciated that multiple virtual floating layers 106′ may be provided to a gaming machine 100′. For example, one virtual floating layer 106′ may be designated to broadcast live media, another may provide patron feedback and/or status (e.g., name, number of credits, amount of bet, etc.), etc. The number of virtual floating layers 106′ may be predetermined and/or patron-based (e.g., as a response to a patron request for a new virtual floating layer 106′, in accordance with the patron's status, etc.). In certain exemplary embodiments, patrons may be charged a premium to have access to one or more virtual floating layers, whereas in certain other exemplary embodiments patrons may have access to virtual floating layers if they are of a preferred or premium status, etc.

In certain exemplary embodiments, the virtual floating layer 106′ may be transparent, semi-transparent, and/or alpha-blended on top of the primary content being displayed. In certain other exemplary embodiments, the virtual floating layer 106′ opaque with respect to the main content. Thus, the virtual floating layer 106′ may completely overshadow or replace the content on either or both of the first and second displays.

When the virtual floating layer 106′ is completely opaque and covers the entire viewable area of a display, additional content partially or entirely independent of the underlying base game may be provided. Thus, certain exemplary embodiments provide completely new games, independent of the underlying games. It will be appreciated that many advantages may be realized in this and related ways. For example, rather than completely replacing machines, existing machines and/or infrastructure may be used to handle new games running thereon. In one exemplary embodiment, the games may be distributed from the central systems 202 to the gaming machines 100′ individually for local execution, whereas in certain other exemplary embodiments a module of the central systems 202 may provide truly distributed gaming. This advantageously reduces the costs associated with changes and provides new and unique upgrades to existing equipment. In essence, the MIC and/or video controller may become the primary controller of the gaming machine. Thus, there is still cooperation with the base gaming machine to the extent that a physical piece of hardware and/or its associated interface are used to provide input to a separate game and/or feedback to the patron.

In certain exemplary embodiments, a full-screen console or portal to a gaming environment may be provided. In such a case, some or all gaming and/or gaming environment (e.g., casino, hotel, valet, drink, etc.) services may be accessible to the patron. For example, the patron may select games to play, media to watch, services to interact with, etc., potentially notwithstanding any base game operating on the base platform. Thus, a wholly contained virtual environment may be provided to the patron by virtue of the full-screen floating layer.

The virtual floating layer 106′ may be in connection with gaming machines that incorporate one or more display devices. In certain exemplary embodiments, the physical hardware display module of the PTM may be completely eliminated and existing information and transactions may be floated and/or layered onto an existing gaming machine. Information, video, and/or the user interface may be floated and/or layered. In certain exemplary embodiments, the hardware to achieve this result optionally may remain completely independent of the base machine.

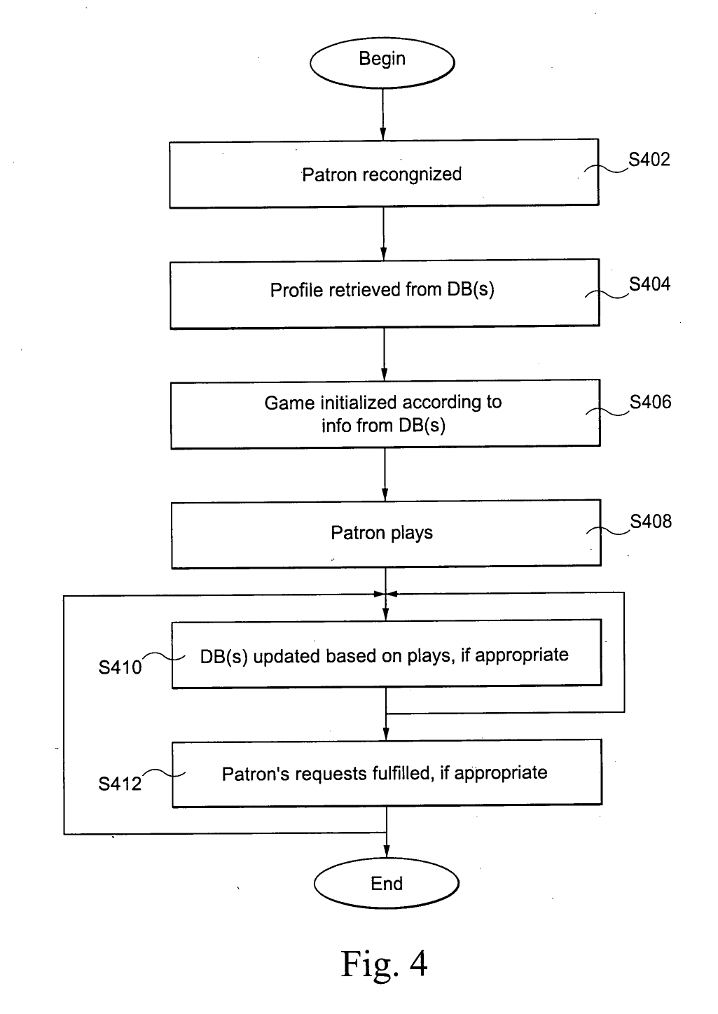

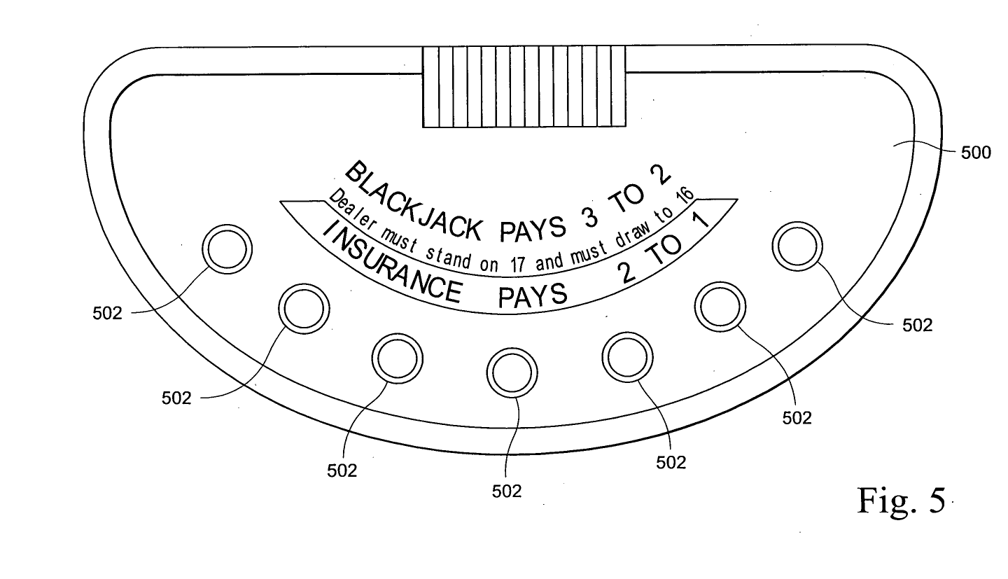

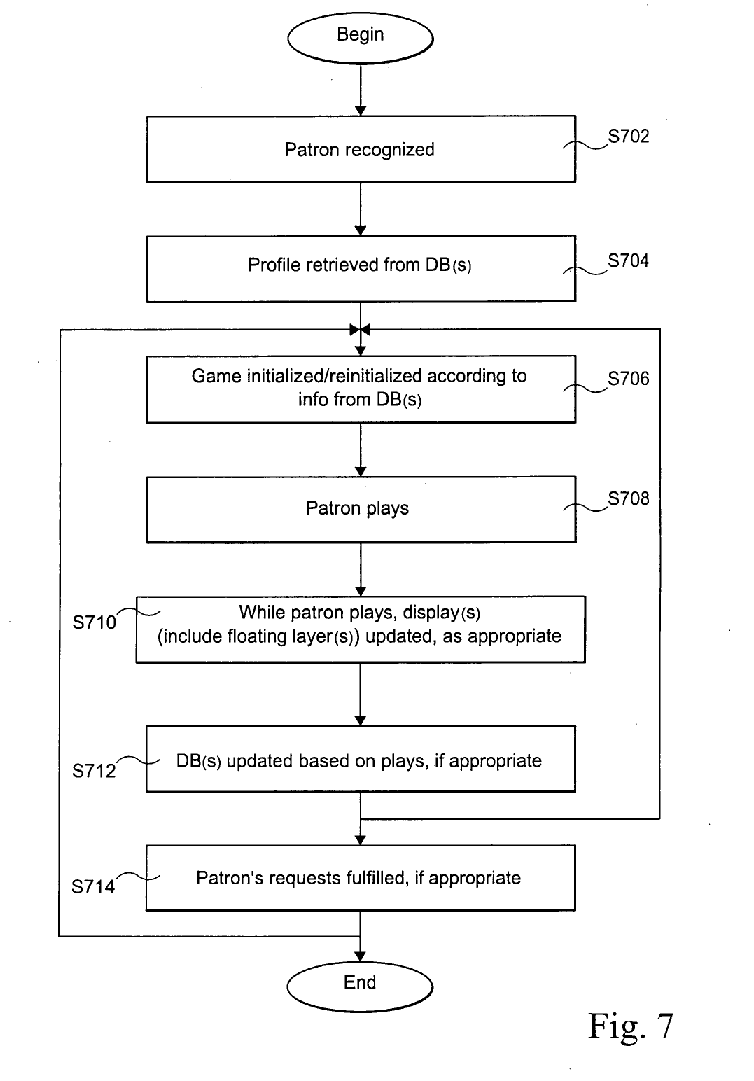

FIG. 7 is an illustrative flowchart demonstrating a process involving a patron using an improved gaming machine, and in the improved networked environment, of FIG. 6, in accordance with an exemplary embodiment. FIG. 7 is similar to FIG. 4. In step S702, the patron is recognized. After the patron is recognized, the patron's profile is retrieved from the database(s) in step S704. Information that may be retrieved and may include the patron's name, room number, number of credits, status (e.g., normal user, preferred patron, etc.), and the like. In step S706, the game to be played on the gaming machine is initialized (or reinitialized) according to the retrieved information where appropriate. The patron plays the game in step S708. In step S710, the display(s), including floating layer(s), are updated as appropriate. In step S712, the database(s) is/are updated based on the plays, when appropriate. Also, in step S714, the patron's requests are fulfilled, where appropriate.

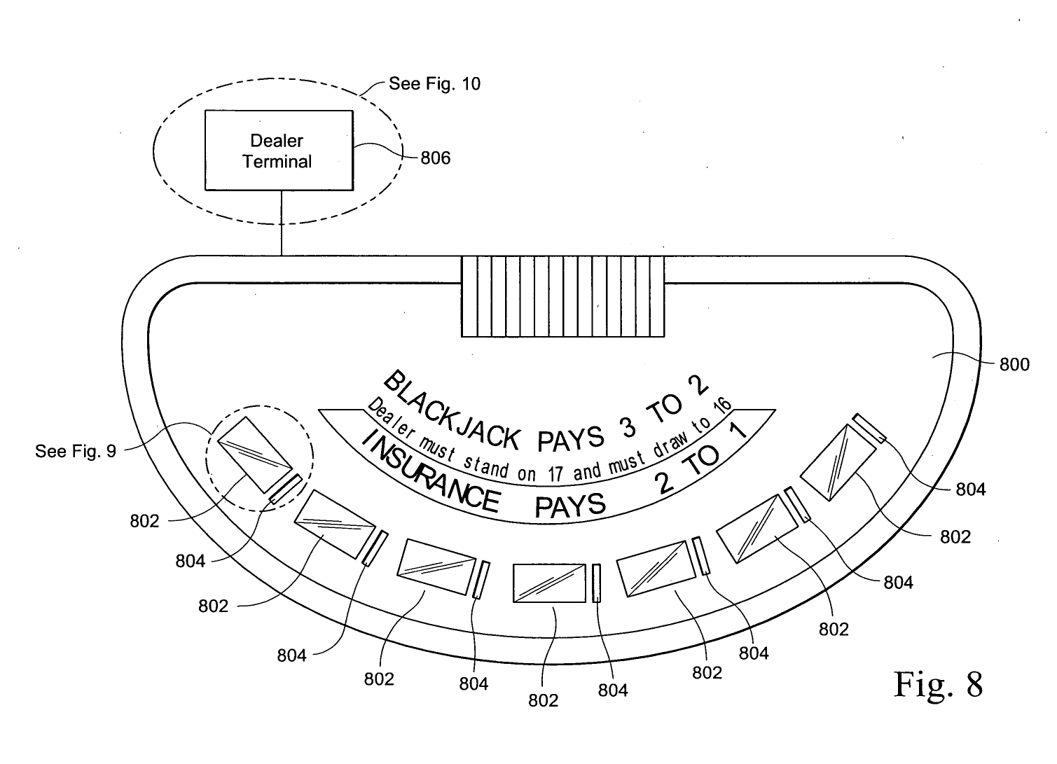

Transitioning now from the gaming machine environment to the table game environment, FIG. 8 is an improved table game in accordance with an exemplary embodiment. In FIG. 8, the improved table 800 has a number of player positions. More particularly, seven player positions are shown because, as noted above, this is the customary number of player positions at blackjack tables, for example. Of course, the invention is not limited to a particular number of player positions.

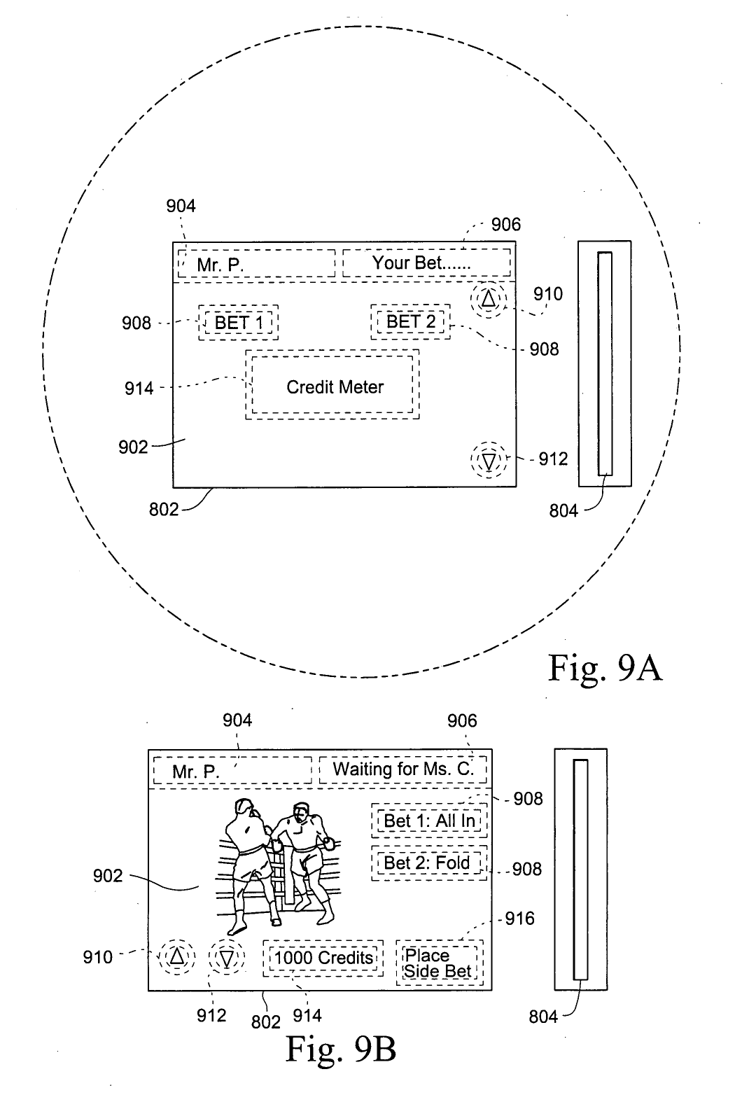

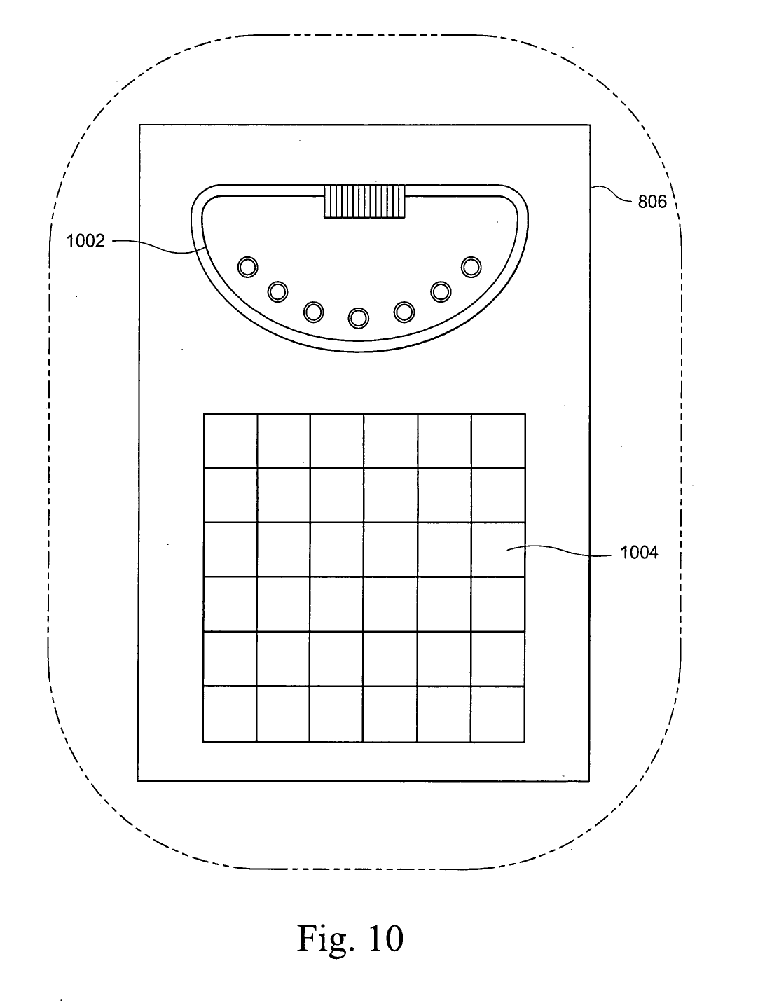

Each player position includes a display 802 and a card reader 804. Further details pertaining to the player positions are provided below with reference to FIGS. 9A-B. There also is a dealer terminal 806. Further details pertaining to the dealer terminal 806 are provided with reference to FIG. 10.

Conventionally, it has not been possible to place a player card reader on a table for each individual patron. The difficulties relate, at least in part, to the manual nature of the table games themselves. Indeed, table games require a significant amount of non-automated, manual personnel services, e.g., for dealing, calculating payouts, recognizing and ranking players, awarding bonuses, cashing out chips, etc. In addition to requiring a paradigm shift to recognize the desirability of having card readers and individualized displays on table games, further difficulties have related to the affordability and attainability of the technology to power such services. Thus, successfully implementing card readers and displays on table games has been a significant challenge that the instant invention has overcome.

FIG. 9A is a more detailed view of an improved patron position from the improved table game of FIG. 8 in accordance with an exemplary embodiment. As shown in FIG. 9A, the display 802 includes a main display area 902 and a number of virtual floating layers located thereon. The patron may have the ability to place side wagers and/or a main wager via the interface. The patron also may use an autoplay feature (which, for example, may automatically play the patron's last bet, the patron's most common bet, etc., until the feature is cancelled). Also, similar to as described above, the main display area 902 may portray conventional PTM features such as, for example, updatable and/or substantially real-time PTM data and a user interface for the patron. This information may include customer feedback (e.g., the patron's name), play data, error codes, and the like. Customer service interaction, including the above noted and/or other ancillary services, also may be enabled. Live feeds may be displayed to patrons individually, and bonus enhancement games, opportunities for side bets, and the like also may be provided.

Further description of such virtual floating layers on the display 802 of a table game will now be made, but it will be appreciated that this description is presented by way of example and without limitation. A patron recognition area 904 includes the patron's name (in this example, “Mr. P.”), and a status area 906 indicates the action taking place at the table (in this case, it is Mr. P's turn to bet). Any number of bets may be made, as reflected in bet areas 908. Control arrows 910, 912 enable the patron, for example, to take actions where appropriate. For example, the control arrows 910, 912 may be used to increase/decrease the wager, change “channels” on the main display area 902, scroll through a menu-based display displayed on the main display area 902, etc. A credit meter 914 also may be displayed to the patron. The credit meter 914 may be, for example, a number, an image of stacks of chips, an image of a pile of money, etc.

FIG. 9B is a simulated illustrative display on the improved patron position from FIG. 9A in accordance with an exemplary embodiment. The display 802 reflected in FIG. 9B has been customized by a hypothetical patron to adjust sizes, positions, and other features of the customizable layers. Thus, in FIG. 9B, the main display area 902 depicts a live-action boxing match. The patron recognition area 904 still indicates that “Mr. P.” is the recognized patron, but the status area 906 indicates that “Mr. P.” is waiting for “Ms. C.” to bet. The bet areas 908 indicate that “Mr. P.” is all in on his first bet, but folded on his second. The control arrows 910, 912 are visible but moved out of the way of the live action boxing match shown on the main display area 902. The credit meter 914 indicates that “Mr. P.” has 1000 credits, and a side bet may be placed using area 916.

FIG. 10 is a more detailed view of a dealer interface 806 from the improved table game of FIG. 8 in accordance with an exemplary embodiment. The dealer interface 806 includes a player representation 1002 and a keypad 1004. The dealer may use the dealer interface 806 to make player credits/debits, retrieve the status of any patron (e.g., amount of credits, whether a preferred patron, etc.), and the like. For example, the dealer may designate a player in the player representation 1002 and indicate, via the keypad 1004, whether to credit/debit the patron's account, what the patron's hand included, etc.

Data may be logged (e.g., to the databases) during the play of each patron.

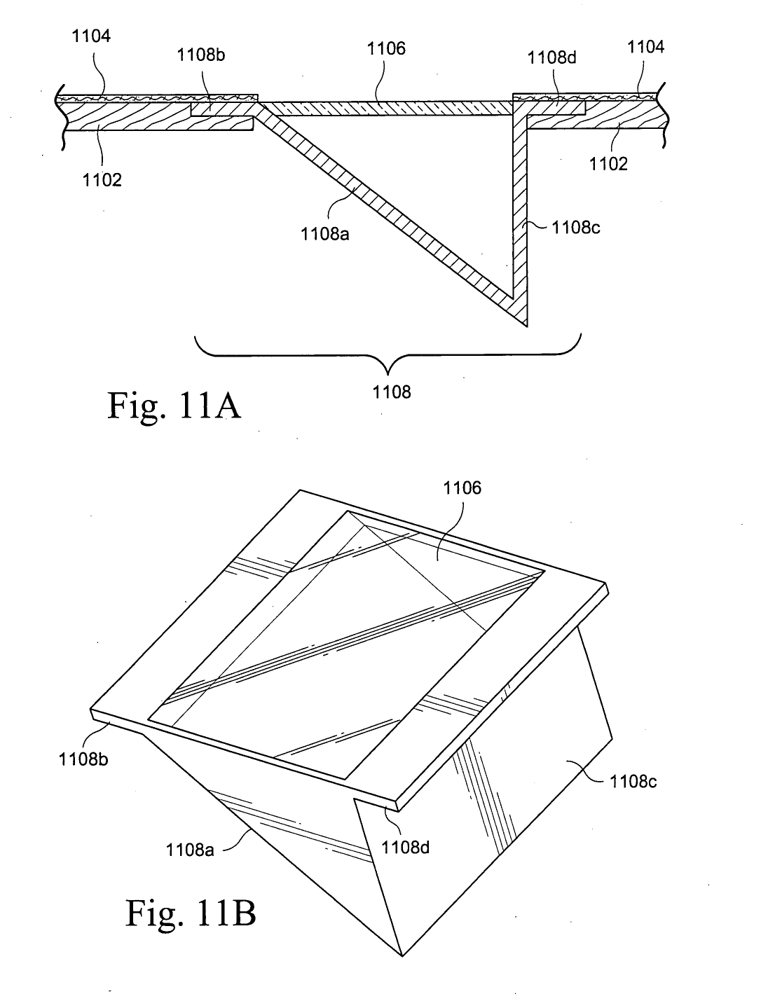

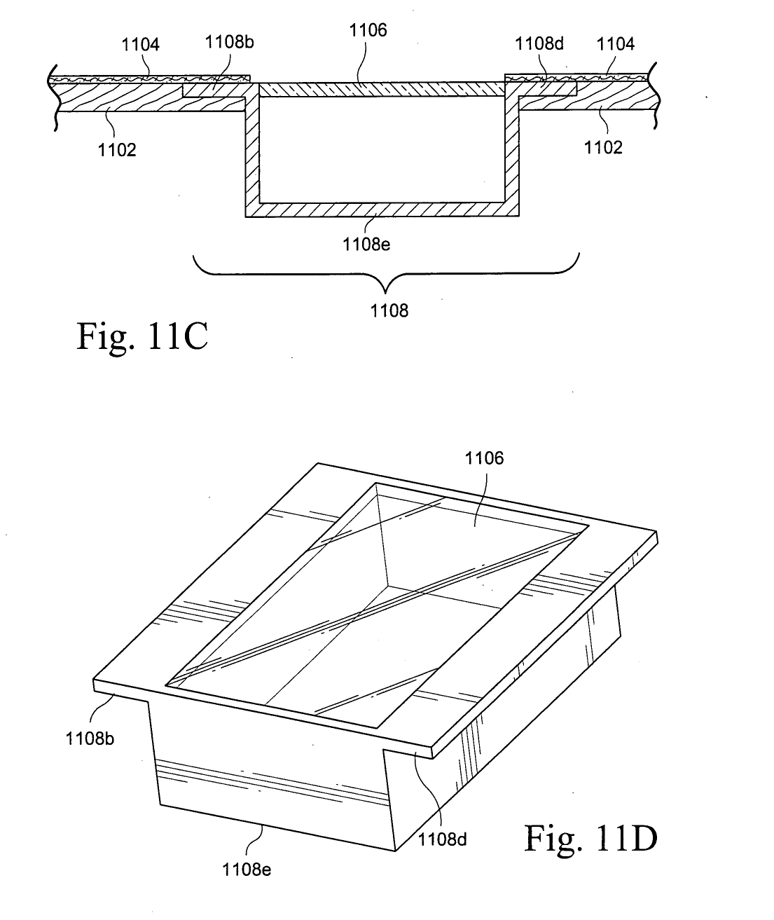

FIG. 11A is a cross-sectional view of an illustrative inset bezel 1108 for connecting display 802 of FIG. 8 at a player position to the improved table game, in accordance with an exemplary embodiment. A hole is formed in the main table 1102 to accommodate the display and/or other hardware. It will be appreciated that the hole in the table may be a through-hole or merely a recess in the table, depending on the exemplary embodiment. An inset bezel 1108 is disposed over the hole to hold the display, which will be located at 1106. In particular, in certain exemplary embodiments, the inset bezel includes an angled support 1108a to support the bottom of the recessed screen. It is angled at an angle away from the surface, and into the body, of the table. A first foot 1108b connects with the table at one side of the hole. In certain exemplary embodiments, the first foot 1108b may be set into a notched-out or recessed portion of the table. Optionally, it may be screwed, adhered, glued, nailed, or otherwise more-fixedly or more-removedly attached the main table surface. A vertical support 1108c extends upwardly from the angled support 1108a, and a second foot 1108d may attach to the table surface in a manner similar to the first foot 1108b. Felt 1104 may be disposed over the main table surface and/or the feet, as appropriate, to finish the table.

Thus, the inset bezel 1108 may be shaped substantially like a right triangle when viewed in cross-section. Thus, the hypotenuse (1108a) is recessed into the table to support the display, while the major leg (at 1106) of the triangle is missing so as to accommodate the display 802. FIG. 11B is a partial perspective view of the inset bezel of FIG. 11A in accordance with an exemplary embodiment. It will be appreciated that the inset bezel 1108 may be a mere frame for holding the display, or it may more akin to a tray.

Of course, it will be appreciated that other shapes may be used in place of the particular inset bezel 1108 shown and described with reference to FIG. 11A. For example, a substantially U-shape inset bezel may be implemented in certain exemplary embodiments. An example of this arrangement is shown in FIG. 11C, which is a cross-section view of another illustrative inset bezel for connecting display 802 of FIG. 8 at a player position to the improved table game, in accordance with an exemplary embodiment, and in FIG. 11D, which is a partial perspective view of the inset bezel of FIG. 11C in accordance with an exemplary embodiment.

In general, any shape may be used for the inset bezel, although the shape of the inset bezel ultimately implemented may be chosen at least in part on the size and shape of the display 802 and/or touch screen to be incorporated into the table. The inset bezel 1108 itself may be formed from any suitable material such as, for example, metal, plastic, etc.

One or more holes may be disposed anywhere in the inset bezel (e.g., along the angled support 1108a or the vertical support 1108c of FIG. 11A, along the base support 1108e or the vertical supports in FIG. 11C, etc.). Such holes may be sized and/or located so as to allow cabling from the display to unobtrusively be routed around the table game. Alternatively or in addition, such holes may be located to allow the display to cool more efficiently.

In this and other ways, a touch screen monitor may be displayed on the main plane of the table or substantially flush with the top surface of the table, with an LCD being located therebeneath, most likely at an angle to accommodate its hardware, as supported by the inset bezel 1108. It will be appreciated that the touch screen may need to be an offset touch screen to take into account any variations in distances and/or angles with respect to the display. The offset may be taken into account by hardware (e.g., of the touch screen, the display, the table, etc.), by software, and/or by any other suitable programmed logic circuitry alone or in combination. The inset bezel 1108 also may enable the hardware components to be more easily accessed and/or replaced (e.g., when damaged, when in need of servicing, etc.) by providing a more convenient entryway into the table game.

The mechanical connections in accordance with certain exemplary embodiments may be advantageously used along with tale games because most gaming jurisdictions in the United States and around the world require the gaming surface to be completely flat. Typically, the only things allowed on the surface of the table are cards, chips or money, and the patron's hands. This connection enables each player position to offer a wide variety of services to a patron in a way that conforms with the standard gaming rules.

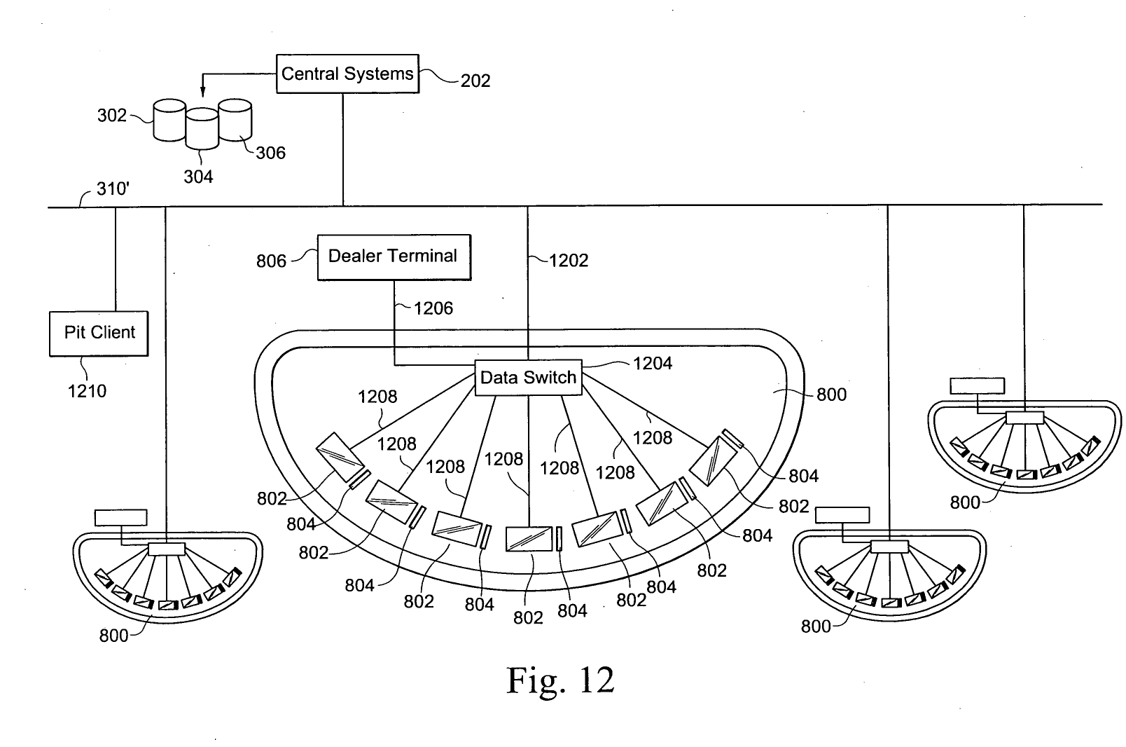

FIG. 12 shows a plurality of improved table games 800 being located on a casino floor and being connected in an improved networked environment in accordance with an exemplary embodiment. As shown in FIG. 12, a connection 1202 is provided to each table 800 from the improved network 310′ so as to connect each respective table 800 to the central systems 202 via a data switch 1204. Via connection 1206, the data switch connects the dealer terminal 806 to the central systems 202. Similarly, via connection 1208, the data switch 1204 connects each of the player positions to the central systems 202.

In certain exemplary embodiments, each table 800 will have its own associated data switch 1204. In such exemplary instances, the network 310′ may be kept more “flat” and thus network latencies may be decreased. However, in certain other exemplary embodiments, the player positions and the dealer terminal may be directly addressable across the network 310′.

A pit client 1210 also sits on the network 310′. The pit client 1210, via its connection to the central systems 202 and to the tables individually, may provide substantially real-time player ratings. These player ratings may be actual, rather than merely estimated, ratings. In addition to actual and substantially real-time ratings, actual substantially real-time player and table accountings may be gathered. Moreover, promotional and/or contributional bonusing may be provided based on an individual's identity, an individual player's rating, on a particular table's action, on the action within a pit, on a property-wide basis, according to a multi-property basis, etc. As described above, using conventional techniques, gathering of such data was extremely cumbersome or even impossible, and the associated features were not achievable with certainty, in real-time, property-wide, and/or without a great degree of manual effort.

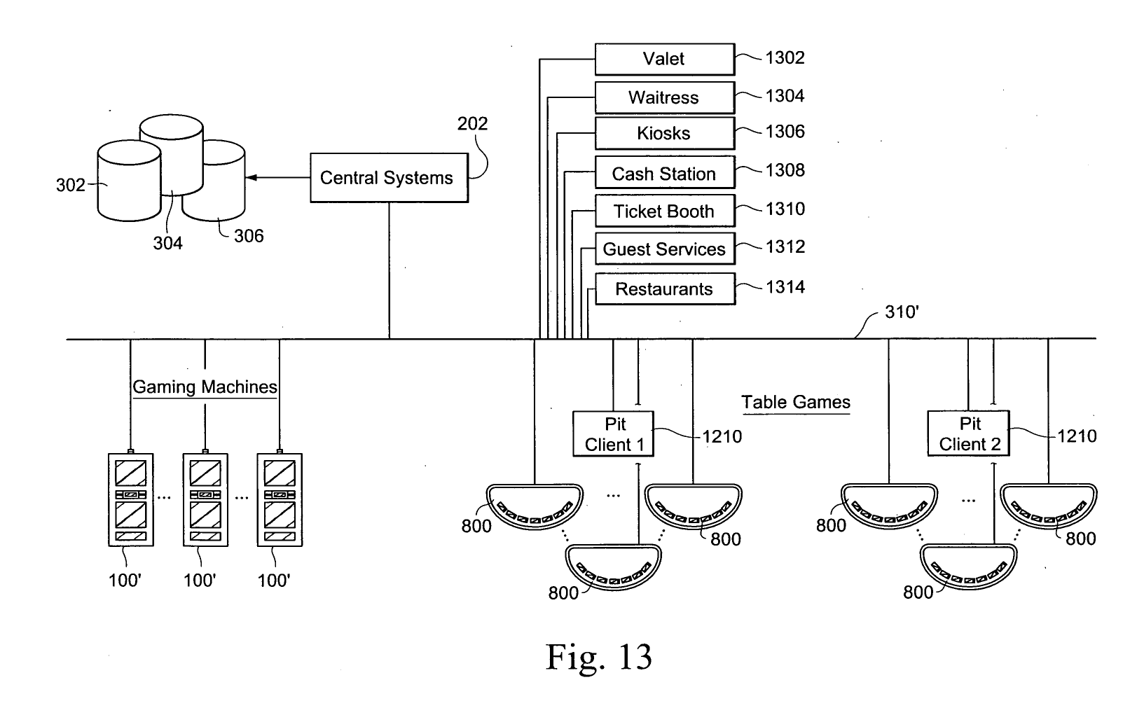

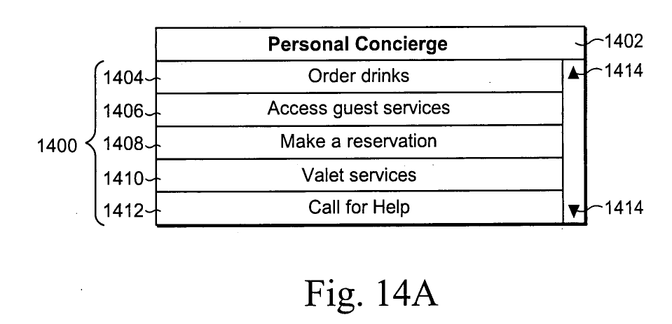

FIG. 13 is a partial schematic view of a casino floor including connections to improved gaming machines 100′ and improved table games 800 in accordance with an exemplary embodiment. The improved gaming machines 100′ and improved table games 800 are, of course, connected to the network 310′. The table games 800 may be divided into one or more pits, as is conventional.

It will be appreciated that, optionally, an improved table game may have a video controller and/or MIC associated with it, similar to the corresponding structures located within the improved gaming machines.

One or more kiosks 1306 may be connected to the network 310′. The kiosks 1306 may display game-related data in various parts of the gaming facility. For example, notifications of big payouts, bonus distributions, total amounts spent and/or earned, etc. may be displayed on the kiosks based on data collected by and maintained in one or more modules of the central systems 202.

One or more cash stations 1308 also may be connected to the network 310′. The cash stations 1308 may allow new patrons to program their identification devices, allow others to add credits, redeem credits, etc.

A number of modules for providing ancillary services to the patrons via the PTMs also are provided. In particular, there is a valet module 1302, a waitress call module 1304, a ticket booth module 1310, a guest services module 1312, and a restaurant module 1314. An exemplary description of several of these modules will be provided with reference to FIGS. 14A-E, although it will be appreciated that the same is provided by way of example and without limitation and that other modules may be implemented additionally in the same or similar fashions.

FIG. 14A is an illustrative menu screen for a personal concierge service in accordance with an exemplary embodiment. The personal concierge service, in general, may be offered as a menu-driven system on a display 1400. It will be appreciated that the display 1400 displaying the personal concierge service may be located on a conventional PTM, as a floating layer on a display of the improved gaming machine (e.g., on the top box, the main game screen, or any other screen), on the screen of an improved table game, as a floating layer on the screen of an improved table game, etc. Control arrows 1414 optionally may be provided. These control arrows may be used to scroll through the menu options displayed on the display 1400, to reveal further options that are “hidden” by virtue of not having enough space on the display, etc. Optionally, the display 1400 may be a touch screen to facilitate user input.

In FIG. 14A, below the identification area 1402 are a number of illustrative menu options. Menu area 1404 enables the user to order drinks, menu area 1406 enables the user to access guess services, menu area 1408 enables the user to make a reservation (e.g., at a restaurant, for a show, a sporting event, etc.), menu area 1410 enables the user to access valet services, and menu area 1412 enables the user to call for help. Of course, it will be appreciated that such options are provided by way of example and without limitation. Other services may be offered in place of, or in addition to, such services.

FIG. 14B is an illustrative, generic flowchart for accessing the features of the personal concierge service in accordance with an exemplary embodiment. User input is accepted in step S1420. The information is transmitted to the appropriate operator in step S1422. In step S1412, the receipt of the user's request is confirmed. This confirmation step may be performed automatically by the system and/or upon actual manual operation (e.g., when a bartender mixes a drink, when a valet retrieves a car, etc.). In step S1426, the user ultimately is notified when the request is fulfilled (e.g., the user may be notified that his car is being retrieved, his car is ready for pickup, his tickets are waiting at will-call, etc.).

FIGS. 14C-E add more detail to this basic process. In particular, FIG. 14C is an illustrative flowchart for requesting drinks via the personal concierge service in accordance with an exemplary embodiment. The user chooses a selection method in step S1430. For example, the user may choose from a list of the user's frequently ordered drinks (e.g., as stored in the central server over a predetermined period of time such as a day, a week, or all-time; as stored in a memory location of the gaming machine or table game itself; etc.) or from a full bar menu. If the user opts to choose from a selection of the user's frequently ordered drinks, such a list will be displayed in step S1432. On the hand, if the user opts to choose from a full menu, for convenience, the user may be required to choose a type of drink (e.g., beer, wine, or liquor or mixed drinks) in step S1434. In such a case, the appropriate list will be displayed based on the user's selection of the type of drink to order in step S1436.

The user may make a selection (e.g., either from the frequently ordered drinks list or from the full menu) in step S1438. The selection may be confirmed in step S1440. Optionally, in step S1442, a time estimate may be provided. As a further optional feature, in step S1444, the user also may be notified when the drinks are on their way.

FIG. 14D is an illustrative flowchart for requesting guest services via the personal concierge service in accordance with an exemplary embodiment. Based on information stored in the central system, in step S1450, whether the user is a guest at the establishment is determined. If the user is not currently a guest, in step S1452, information is collected regarding the user's intended stay. Such information may include, for example, the number of nights the user wishes to stay, the number of rooms the user wishes to occupy, the type of room requested (e.g., smoking/non-smoking, single/double occupancy, beds, suite, etc.), etc. After this information is gathered, in step S1454, it is determined whether the user wishes to make any further guest services related requests. If not, a confirmation simply is provided in step S1466, and the process is ended.

In the case that the user currently is a guest at the establishment or after a non-guest has registered to become a guest, in step S1456, the user may make an appropriate guest service type request. For example, the guest may remotely check out. Thus, step S1458 would process the check-out request, e.g., by charging the credit card, alerting the management, etc. The user optionally may extend the stay in step S1460, by providing, for example, the number of additional nights the user wishes to stay, whether there are any room change requests, etc. In another example, the user may request room service. In such a case, a room service menu may be displayed in step S1462. User input (e.g., delivery time, food/beverage choices, etc.) may be accepted in step S1464. A confirmation of the guest service related request is provided in step S1466, and the process is ended.

FIG. 14E is an illustrative flowchart for making reservations via the personal concierge service in accordance with an exemplary embodiment. The user chooses to make a reservation in step S1470. The user selects the type of reservation in step S1472. For example, the user may request a reservation at a restaurant, at an event (e.g., a show, sporting event, concert, etc.), etc. If the user is making a restaurant reservation, the user enters the location (e.g., restaurant), the desired time, the size of the party, etc., in step S1474. The user even may select from an applicable food/beverage menu, e.g., so that the order is placed and ready when the user arrives. Similarly, if the user is making an event reservation, the user enters the event (e.g., show, sporting event, concert, etc.), the desired time or showing, the number of tickets requested, etc., in step S1476. It will be appreciated that the restaurant or event need not necessarily be on the particular location's property. For example, tickets may be purchased for a fight taking place at another commonly-owned property, restaurants apart from casinos may have partnered with said casinos, etc.

The request is confirmed in step S1478. Optionally, in step S1480, a reminder may be displayed at a specified or predefined time (e.g., 15 minutes, 30 minutes, etc., before the reservation).

For the valet application, the user may “call up” through a menu selection the valet service, which prompts the user for ticket number or retrieves valet and vehicle information from the central system automatically. Once the information is entered or retrieved, the valet module in the valet department prompts the attendant to retrieve that particular patron's vehicle. Once the vehicle is in the pickup area, the attendant signals back to the patron's interface through the valet module that his/her vehicle is ready for pickup. At that point, the patron may end the game session and exit the premises.

As noted above, the player is provided with a personal interface device that provides gaming data and play feedback to the customer as well as assistance and waitress calls. However, the call functions are simply a candle color change on top of the gaming machine or a buzzer call in a department. The exemplary embodiments described herein convey numerous advantages over these traditional techniques. For example, a more comprehensive range of more customized services may be offered. The patron may spend more time participating in and enjoying gaming and casino related activities, e.g., rather than waiting for a car to be picked up, waiting through ticket or restaurant lines, etc. The casino may realize additional revenues during the increased play time. Casinos also may more effectively and efficiently run their operations, for example, by allowing their valet departments to control and/or manage their traffic, reducing the back-and-forth of waitresses, reducing personnel selling tickets and taking reservations, etc.

Using such services, it may be possible to completely replace dealers, chips and/or money, and/or cards, with visual representations of the same being displayed on individual player positions of the improved tables.

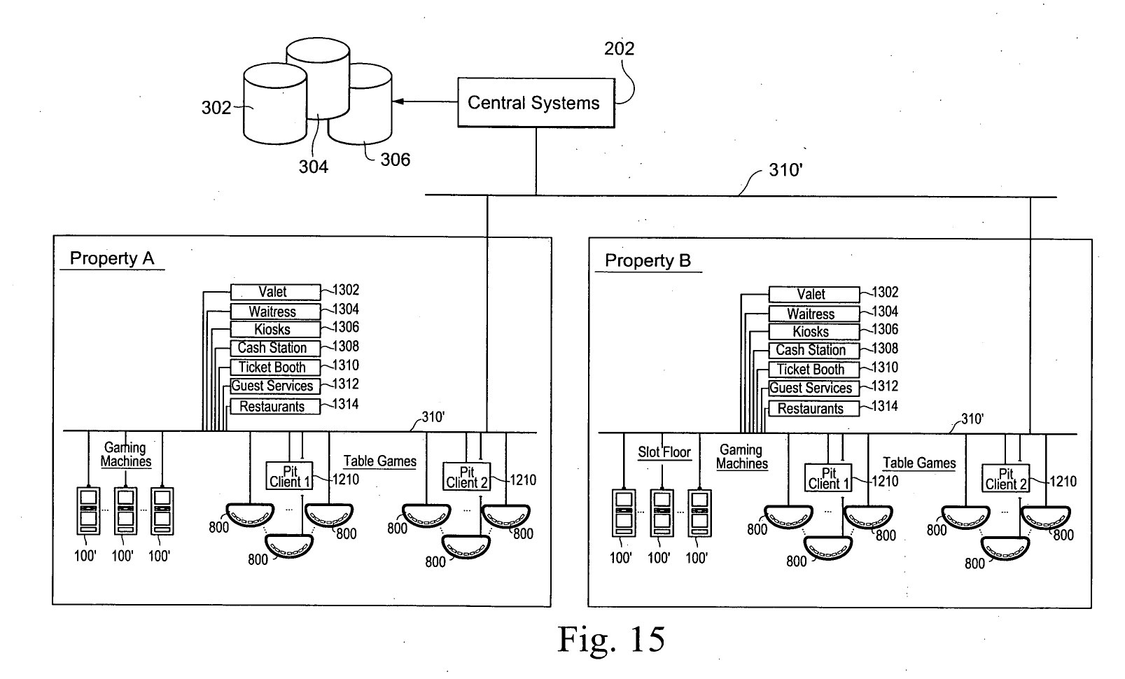

FIG. 15 is an illustrative multi-property layout of improved gaming machines and improved table games in accordance with an exemplary embodiment. In certain exemplary embodiments, some or all of the above-described features may be provided across multiple properties. Thus, for example, player profiles may follow patrons across multiple locations, reservations may be made at any suitably configured restaurant, bonuses may be awarded in line with a broader cross-section of patrons and/or player positions, etc.

It will be appreciated that although certain exemplary embodiments have been described as relating to gaming machines and table games, the present invention is not so limited. For example, the exemplary techniques associated with gaming machines may be used on table games, and vice versa. Moreover, the exemplary techniques may be used on both gaming machines and table games, simultaneously, in a suitably configured networked environment. Also, the techniques may be applied to roulette tables, bingo games, etc.

Although certain exemplary embodiments have been described as relating to gaming machines and table games in casinos, it will be appreciated that the present invention is not so limited. For example, the exemplary embodiments described herein may be used in connection with casinos, riverboats, restaurants, hotels, etc.

Thus, the exemplary features, aspects, and advantages described herein may be combined in yet further ways to achieve further embodiments.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A gaming machine, comprising:
a main screen configured to display a first game-related event;
a top box configured to display a second game-related event;
a video controller configured to provide to the main screen and/or the top box a floatable layer, the floatable layer including at least one ancillary event; and,
a network interface configured to communicate information between the gaming machine and a central system over a network in substantially real-time.

2. The gaming machine of claim 1, wherein main screen and/or the top box each include touch screen functionality.

3. The gaming machine of claim 1, wherein the at least one ancillary event is a floating player tracking module.

4. The gaming machine of claim 3, wherein the video controller is configured to alpha-blend the floating player tracking module onto the main screen and/or the top box such that the floating player tracking module is at least semi-transparent.

5. The gaming machine of claim 3, wherein the video controller is configured to display the floating player tracking module as being opaque with respect to the main screen and/or the top box so as to at least partially cover the main screen and/or the top box.

6. The gaming machine of claim 3, wherein the floating player tracking module is movable and/or resizable.

7. The gaming machine of claim 6, wherein the floating player tracking module and/or resizable based on user input received by the gaming machine.

8. The gaming machine of claim 3, wherein the floating player tracking module is configured to provide streaming media.

9. The gaming machine of claim 3, wherein the floating player tracking module is configured to provide customer feedback and/or play data.

10. The gaming machine of claim 3, wherein the floating player tracking module includes a personal concierge module.

11. The gaming machine of claim 3, wherein the floating player tracking module includes an integrated product services module.

12. The gaming machine of claim 1, wherein the at least one ancillary event is a floating enhancement and/or bonusing opportunity.

13. The gaming machine of claim 12, wherein the video controller is configured to alpha-blend the at least one ancillary event onto the main screen and/or the top box such that the at least one ancillary event is at least semi-transparent.

14. The gaming machine of claim 12, wherein the video controller is configured to display the at least one ancillary event as being opaque with respect to the main screen and/or the top box so as to at least partially cover the main screen and/or the top box.

15. The gaming machine of claim 12, wherein the at least one ancillary event is movable and/or resizable.

16. The gaming machine of claim 15, wherein the at least one ancillary event is movable and/or resizable based on user input received by the gaming machine.

17. The gaming machine of claim 12, wherein the floating enhancement is a random reward.

18. The gaming machine of claim 12, wherein the floating enhancement is a bonus game.

19. The gaming machine of claim 12, wherein the floating enhancement is a displayed to at least one other gaming machine connected to the network.

20. The gaming machine of claim 12, wherein the bonusing opportunity is based on an individual user's play or identity.

21. The gaming machine of claim 12, wherein the bonusing opportunity is based on play of at least some of users using gaming machines connected to the network.

22. The gaming machine of claim 12, wherein the floating enhancement and/or bonusing opportunity is randomly made available by the central system.

23. The gaming machine of claim 12, wherein the floating enhancement and/or bonusing opportunity includes random rewards.

24. The gaming machine of claim 1, wherein the at least one ancillary event is a replacement game, the replacement game being independent of any games displayed on the main screen and/or the top box.

25. The gaming machine of claim 24, wherein the video controller is configured to display the at least one ancillary event as being opaque with respect to the main screen and/or the top box so as to at least partially cover the main screen and/or the top box.

26. The gaming machine of claim 24, wherein a jackpot and/or reward is calculated based at least in part on user interaction with the replacement game.

27. The gaming machine of claim 24, wherein game status is determined based at least in part on user operation of the replacement game.

28. The gaming machine of claim 27, wherein game status includes at least one of: an amount of wager, game play, rules for payout, calculation of payout, and payout.

29. The gaming machine of claim 1, wherein the network is a multicast network arranged in a plurality of layers.

30. The gaming machine of claim 29, wherein at least some of the layers are dedicated to providing instances of media, each layer providing a single instance of media.

31. The gaming machine of claim 30, wherein the network interface is configured to receive a layer based on user input.

32. The gaming machine of claim 29, wherein at least some of the layers are dedicated to providing different games, each layer providing a different game.

33. The gaming machine of claim 32, wherein the network interface is configured to receive a layer based on user input.

34. The gaming machine of claim 32, wherein the network interface is configured to receive a layer based on a unique identifier associated with the gaming machine.

35. The gaming machine of claim 29, wherein the network interface is configured to communicate the information between the gaming machine and a central system over a layer designated for the gaming machine.

36. A floatable layer to be provided to a main screen configured to display a first game-related event and/or a top box configured to display a second game-related event of a gaming machine,
wherein the floatable layer is configured to display at least one ancillary event, and
wherein the gaming machine includes a network interface configured to communicate information between the gaming machine and a central system over a network in substantially real-time.

37. The floatable layer of claim 36, wherein the at least one ancillary event is a floating player tracking module.

38. The floatable layer of claim 37, wherein a video controller of the gaming machine is configured to alpha-blend the floating player tracking module onto the main screen and/or the top box such that the floating player tracking module is at least semi-transparent.

39. The floatable layer of claim 37, wherein a video controller of the gaming machine is configured to display the floating player tracking module as being opaque with respect to the main screen and/or the top box so as to at least partially cover the main screen and/or the top box.

40. The floatable layer of claim 37, wherein the floating player tracking module is movable and/or resizable.

41. The floatable layer of claim 40, wherein the floating player tracking module and/or resizable based on user input received by the gaming machine.

42. The floatable layer of claim 37, wherein the floating player tracking module is configured to provide streaming media.

43. The floatable layer of claim 37, wherein the floating player tracking module is configured to provide customer feedback and/or play data.

44. The floatable layer of claim 37, wherein the floating player tracking module includes a personal concierge module.

45. The floatable layer of claim 37, wherein the floating player tracking module includes an integrated product services module.

46. The floatable layer of claim 36, wherein the at least one ancillary event is a floating enhancement and/or bonusing opportunity.

47. The floatable layer of claim 46, wherein a video controller of the gaming machine is configured to alpha-blend the at least one ancillary event onto the main screen and/or the top box such that the at least one ancillary event is at least semi-transparent.

48. The floatable layer of claim 46, wherein a video controller of the gaming machine is configured to display the at least one ancillary event as being opaque with respect to the main screen and/or the top box so as to at least partially cover the main screen and/or the top box.

49. The floatable layer of claim 46, wherein the at least one ancillary event is movable and/or resizable.

50. The floatable layer of claim 49, wherein the at least one ancillary event is movable and/or resizable based on user input received by the gaming machine.

51. The floatable layer of claim 46, wherein the floating enhancement is a random reward.

52. The floatable layer of claim 46, wherein the floating enhancement is a bonus game.

53. The floatable layer of claim 46, wherein the floating enhancement is a displayed to at least one other gaming machine connected to the network.

54. The floatable layer of claim 46, wherein the bonusing opportunity is based on an individual user's play or identity.

55. The floatable layer of claim 46, wherein the bonusing opportunity is based on play of at least some of users using gaming machines connected to the network.

56. The floatable layer of claim 46, wherein the floating enhancement and/or bonusing opportunity is randomly made available by the central system.

57. The floatable layer of claim 46, wherein the floating enhancement and/or bonusing opportunity includes random rewards.

58. The floatable layer of claim 36, wherein the at least one ancillary event is a replacement game, the replacement game being independent of any games displayed on the main screen and/or the top box.

59. The floatable layer of claim 58, wherein a video controller of the gaming machine is configured to display the at least one ancillary event as being opaque with respect to the main screen and/or the top box so as to at least partially cover the main screen and/or the top box.

60. The floatable layer of claim 58, wherein a jackpot and/or reward is calculated based at least in part on user interaction with the replacement game.

61. The floatable layer of claim 58, wherein game status is determined based at least in part on user operation of the replacement game.

62. The floatable layer of claim 61, wherein game status includes at least one of: an amount of wager, game play, rules for payout, calculation of payout, and payout.

63. The floatable layer of claim 36, wherein the network is a multicast network arranged in a plurality of layers.

64. The floatable layer of claim 63, wherein at least some of the layers are dedicated to providing instances of media, each layer providing a single instance of media.

65. The floatable layer of claim 64, wherein the network interface is configured to receive a layer based on user input.

66. The floatable layer of claim 63, wherein at least some of the layers are dedicated to providing different games, each layer providing a different game.

67. The floatable layer of claim 66, wherein the network interface is configured to receive a layer based on user input.

68. The floatable layer of claim 66, wherein the network interface is configured to receive a layer based on a unique identifier associated with the gaming machine.

69. The floatable layer of claim 63, wherein the network interface is configured to communicate the information between the gaming machine and a central system over a layer designated for the gaming machine.

70. A gaming network including a plurality of gaming machines, each gaming machine comprising:
a main screen configured to display a first game-related event;
a top box configured to display a second game-related event;
a video controller configured to provide to the main screen and/or the top box a floatable layer, the floatable layer including at least one ancillary event; and,
a network interface configured to communicate information between the gaming machine and a central system over the network in substantially real-time.

71. The gaming network of claim 70, wherein, for at least some of the gaming machines in the gaming network, the main screen and/or the top box each include touch screen functionality.

72. The gaming network of claim 70, wherein, for at least some of the gaming machines in the gaming network, the at least one ancillary event is a floating player tracking module.

73. The gaming network of claim 72, wherein, for at least some of the gaming machines in the gaming network, the video controller is configured to alpha-blend the floating player tracking module onto the main screen and/or the top box such that the floating player tracking module is at least semi-transparent.

74. The gaming network of claim 72, wherein, for at least some of the gaming machines in the gaming network, the video controller is configured to display the floating player tracking module as being opaque with respect to the main screen and/or the top box so as to at least partially cover the main screen and/or the top box.

75. The gaming network of claim 72, wherein, for at least some of the gaming machines in the gaming network, the floating player tracking module is movable and/or resizable.

76. The gaming network of claim 75, wherein, for at least some of the gaming machines in the gaming network, the floating player tracking module and/or resizable based on user input received by the gaming machine.

77. The gaming network of claim 72, wherein, for at least some of the gaming machines in the gaming network, the floating player tracking module is configured to provide streaming media.

78. The gaming network of claim 72, wherein, for at least some of the gaming machines in the gaming network, the floating player tracking module is configured to provide customer feedback and/or play data.

79. The gaming network of claim 72, wherein, for at least some of the gaming machines in the gaming network, the floating player tracking module includes a personal concierge module.

80. The gaming network of claim 72, wherein, for at least some of the gaming machines in the gaming network, the floating player tracking module includes an integrated product services module.

81. The gaming network of claim 70, wherein, for at least some of the gaming machines in the gaming network, the at least one ancillary event is a floating enhancement and/or bonusing opportunity.

82. The gaming network of claim 81, wherein, for at least some of the gaming machines in the gaming network, the video controller is configured to alpha-blend the at least one ancillary event onto the main screen and/or the top box such that the at least one ancillary event is at least semi-transparent.

83. The gaming network of claim 81, wherein, for at least some of the gaming machines in the gaming network, the video controller is configured to display the at least one ancillary event as being opaque with respect to the main screen and/or the top box so as to at least partially cover the main screen and/or the top box.

84. The gaming network of claim 81, wherein, for at least some of the gaming machines in the gaming network, the at least one ancillary event is movable and/or resizable.

85. The gaming network of claim 84, wherein, for at least some of the gaming machines in the gaming network, the at least one ancillary event is movable and/or resizable based on user input received by the gaming machine.

86. The gaming network of claim 81, wherein, for at least some of the gaming machines in the gaming network, the floating enhancement is a random reward.

87. The gaming network of claim 81, wherein, for at least some of the gaming machines in the gaming network, the floating enhancement is a bonus game.

88. The gaming network of claim 81, wherein, for at least some of the gaming machines in the gaming network, the floating enhancement is a displayed to at least one other gaming machine connected to the network.

89. The gaming network of claim 81, wherein, for at least some of the gaming machines in the gaming network, the bonusing opportunity is based on an individual user's play or identity.

90. The gaming network of claim 81, wherein, for at least some of the gaming machines in the gaming network, the bonusing opportunity is based on play of at least some of users using gaming machines connected to the network.

91. The gaming network of claim 81, wherein, for at least some of the gaming machines in the gaming network, the floating enhancement and/or bonusing opportunity is randomly made available by the central system.

92. The gaming network of claim 81, wherein, for at least some of the gaming machines in the gaming network, the floating enhancement and/or bonusing opportunity includes random rewards.

93. The gaming network of claim 70, wherein, for at least some of the gaming machines in the gaming network, the at least one ancillary event is a replacement game, the replacement game being independent of any games displayed on the main screen and/or the top box.

94. The gaming network of claim 93, wherein, for at least some of the gaming machines in the gaming network, the video controller is configured to display the at least one ancillary event as being opaque with respect to the main screen and/or the top box so as to at least partially cover the main screen and/or the top box.

95. The gaming network of claim 93, wherein, for at least some of the gaming machines in the gaming network, a jackpot and/or reward is calculated based at least in part on user interaction with the replacement game.

96. The gaming network of claim 93, wherein, for at least some of the gaming machines in the gaming network, game status is determined based at least in part on user operation of the replacement game.

97. The gaming network of claim 96, wherein, for at least some of the gaming machines in the gaming network, game status includes at least one of: an amount of wager, game play, rules for payout, calculation of payout, and payout.

98. The gaming network of claim 70, wherein, for at least some of the gaming machines in the gaming network, the network is a multicast network arranged in a plurality of layers.

99. The gaming network of claim 98, wherein, for at least some of the gaming machines in the gaming network, at least some of the layers are dedicated to providing instances of media, each layer providing a single instance of media.

100. The gaming network of claim 99, wherein, for at least some of the gaming machines in the gaming network, the network interface is configured to receive a layer based on user input.

101. The gaming network of claim 98, wherein, for at least some of the gaming machines in the gaming network, at least some of the layers are dedicated to providing different games, each layer providing a different game.

102. The gaming network of claim 101, wherein, for at least some of the gaming machines in the gaming network, the network interface is configured to receive a layer based on user input.

103. The gaming network of claim 101, wherein, for at least some of the gaming machines in the gaming network, the network interface is configured to receive a layer based on a unique identifier associated with the gaming machine.

104. The gaming network of claim 98, wherein, for at least some of the gaming machines in the gaming network, the network interface is configured to communicate the information between the gaming machine and a central system over a layer designated for the gaming machine.
